(19) United States
(12) Patent Application Publication
(10) Pub. No.: US 2026/0334367 A1
(43) Pub. Date: Oct. 29, 2026

(54) HAY RAKE CADDY

(71) Applicant: WILLIAM JOSEPH HYNES, JR., VAN, TX (US)

(72) Inventor: WILLIAM JOSEPH HYNES, JR., VAN, TX (US)

(21) Appl. No.: 19/663,009

(22) Filed: Apr. 29, 2026

Related U.S. Application Data
(60) Provisional application No. 63/796,719, filed on Apr. 29, 2025.

(51) Int. Cl. A01D 78/14

(52) U.S. Cl. CPC A01D 78/146

(57) ABSTRACT

A hay rake caddy includes a frame to support a cross member with wheels for towing behind a tractor and simultaneously towing a baler. The frame has a first hitch mount at a first end and a second hitch mount at a second end. The cross member extends across the frame and elevate the frame above the ground. A rail runs along the frame and is configured to support a rotating shaft. A hay rake is coupled to the rail and is operative between a raised and lowered position. An operator locates the hay rake caddy between the tractor and a baler to permit for the simultaneous gathering of hay into rows and baling the hay.

### CROSS REFERENCE TO RELATED APPLICATIONS:

This application claims the benefit of an earlier filing date and right of priority to U.S. Provisional Application No. 63/796,719, filed 29 Apr. 2025, the contents of which is incorporated by reference herein in its entirety.

### BACKGROUND OF THE INVENTION

### 1. Field of the Invention

The present application relates to a hay raking apparatus, and more particularly to a hay rake caddy situated between a tractor and a hay baler.

### 2. Description of Related Art

Traditionally, hay harvesting requires separate machinery and significant manual effort, contributing to higher costs, prolonged time, and increased equipment wear. Hay harvesting, while essential for livestock producers, remains labor-intensive and time-consuming despite advances in agricultural machinery. The current raking process often necessitates multiple pieces of equipment, requiring additional manpower, tractors, and fuel consumption. This leads to higher operating costs, increased wear and tear on machinery, and reduced efficiency in the overall harvesting process.

Moreover, the need to frequently adjust and monitor equipment during raking creates inefficiencies and safety risks for operators. Existing solutions fail to address the integration of raking and baling in a manner that optimizes both time and labor while maintaining high-quality output. The lack of a unified system exacerbates the challenges of harvesting hay in varied weather conditions, further complicating an already demanding task. Although strides have been made, shortcomings remain.

### BRIEF SUMMARY OF THE INVENTION

It is an object of the present application to provide a hay rake caddy that is configured to extend between a tractor and a baler. It is an object of the present application that the caddy be configured to link the PTO of the tractor with the baler. The hay rake caddy is designed to permit an operator to simultaneously rake up cut hay into rows and bale the hay.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a hay rake caddy according to an embodiment of the present application.

FIG. 2 is a top view of the hay rake caddy of FIG. 1 illustrating the movement of hay.

FIG. 3 is a front perspective view of the hay rake caddy of FIG. 1.

FIG. 4 is a rear perspective view of the hay rake caddy of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The hay rake caddy of the present application is configured to revolutionize hay harvesting by streamlining the raking and baling processes into a single, efficient operation. The hay rake caddy offers a robust solution that saves time, reduces labor, and enhances productivity. Its compatibility with any brand of hay rake ensures broad applicability, making it an essential tool for modern agricultural operations.

The caddy of the present application is engineered with a heavy-duty steel frame and advanced hydraulic and electrical systems. The hay rake caddy integrates seamlessly between the tractor and baler. The rake includes an adjustable V-shaped configuration to funnel hay rows directly into the baler's pickup reel, thereby minimizing the need for multiple passes. The tractor can tow the hay rake caddy which in turn can tow the baler at the same time. The steps of gathering the cut hay into rows and baling can be done with a single pass of the tractor. With its efficient design, durable construction, and user-friendly operation, the hay rake caddy ensures long-term value and reliability for livestock producers and feed growers.

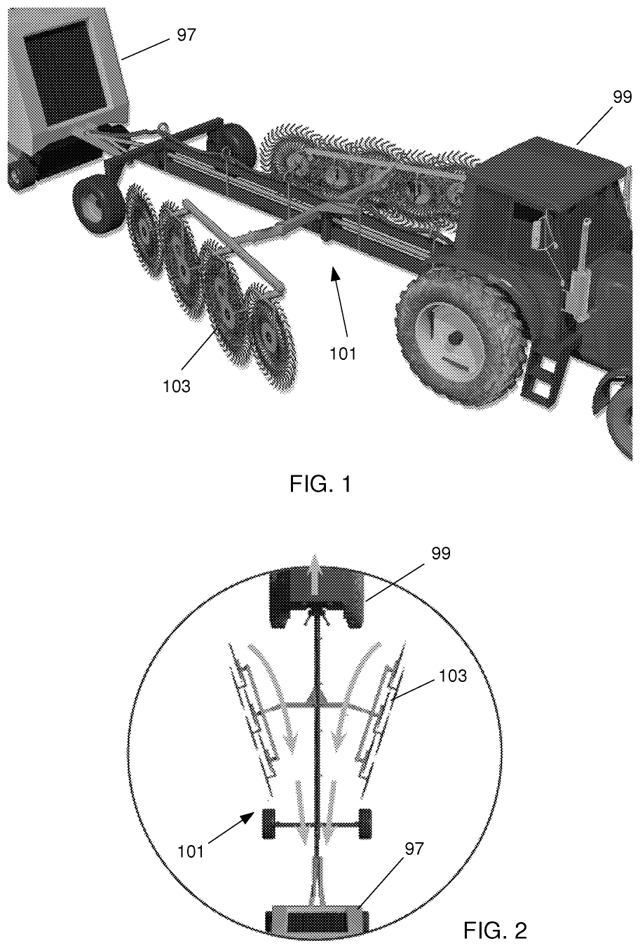

Referring now to FIGS. 1-4 in the drawings, a hay rake caddy is illustrated in various views. As seen in FIG. 1, the hay rake caddy 101 of the present application is configured to be pulled by a tractor 99 and in turn pull in front of a hay baler 97. Caddy 101 bridges the distance between baler 97 and tractor 99 for the purpose of eliminating additional unneeded steps in the hay making process. As seen in the top view of FIG. 2, the arrows illustrate the direction of hay collection as tractor 99 moves forward as indicated.

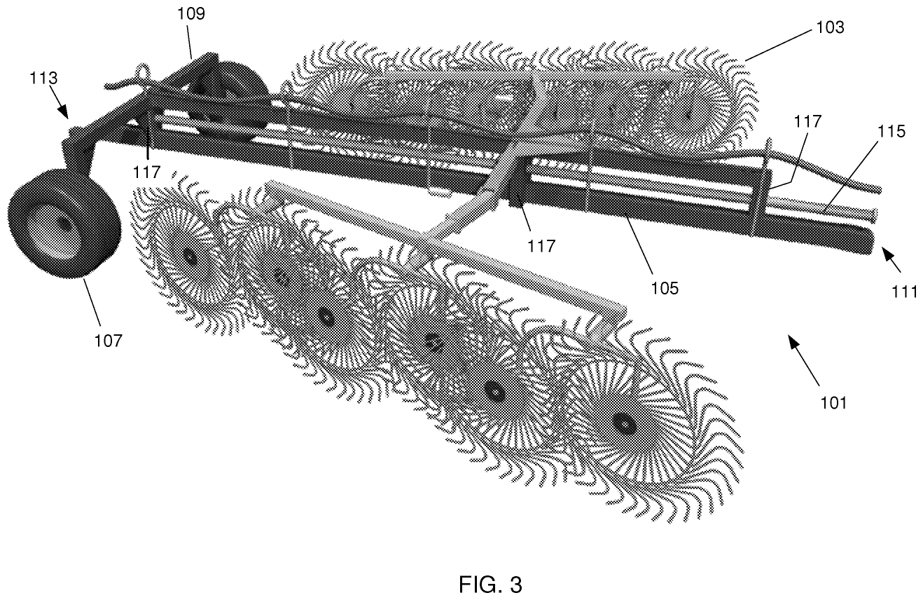

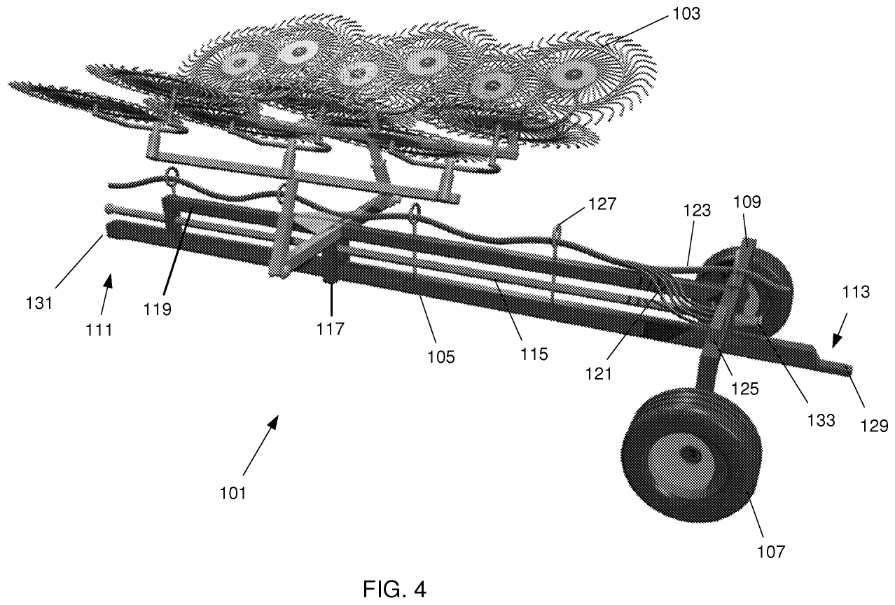

A hay rake 103 is coupled to caddy 101 and is configured to collect and align cut hay into the path of baler 97 for baling. Figures three and four in the drawings provide. enlarged perspective views of hay rake caddy 101. Rake 103 is configured to operate between a raised position as seen in FIG. 4 and a lowered position as seen in FIG. 3. Rake 103 operates very similar to legacy or existing hay rake devices. It is configured to funnel hay dispersed over a wide area and move it into a narrowed position suitable for picking up by a baler 97.

Hay rake caddy 101 is configured to combine raking and bailing into a single pass with a tractor. Caddy 101 is configured to be made from heavy duty steel components that are robust and able to provide long service life. Caddy 101 is also configured to operate with rake 103 which is able to be selectively coupled to a portion of caddy 101 for its operation. It is understood that caddy 101 may be operated entirely from the tractor seat so as to eliminate the need for extra tractors or manpower or even the inclusion of additional hydraulics or electronic controls.

As seen in FIGS. 3 and 4 of the drawings, hay rake caddy 101 includes a steel frame 105. Frame 105 is configured to ride upon tires 107. Tires 107 are typical with those of agricultural equipment and may have various styles of treads or be made from various different materials. Frame 105 includes a first end 111 and a second end 113. Tractor 99 is configured to couple adjacent to first end 111 and baler 97 is configured to couple adjacent second end 113. A cross member 109 is coupled to frame 105 and is configured to pass on either side of frame 105 to support tires 107. Cross member 109 is situated adjacent a second end of frame 105.

Cross member 109 is coupled to frame 105 adjacent second end 113 and is configured to support or elevate frame 105 above the ground. Cross member 109 is also configured to support rotating shaft 115. Cross member 109 may include a permit passage of rotating shaft 115. Rotating shaft 115 is configured to couple to the PTO of tractor 99 and serve as an extension of that PTO along the length of frame 105. Member 109 may include a gusset or web (i.e. support 117) to directly support or attach to frame 105 and rotating shaft 115.

In operation, baler 97 is configured to couple to rotating shaft 115 at second end 113. Wherein existing configurations of a baler 97 and tractor 99 would allow for baler 97 to coupled directly to the PTO shaft of tractor 99, the use of caddy 101 necessitates an extension, or in other words rotating shaft 115 to communicate baler 97 with the PTO shaft of tractor 99. Rotating shaft 115 is elevated along with frame 105 through the use of supports 117. Any number of bearings may be utilized to permit the seamless and smooth rotation of shaft 115 in supports 117. It should also be noted that any number of supports 117 may be utilized. Sufficient numbers of supports 117 should be used to eliminate wobble in shaft 115.

As seen in the figures, cross member 109 is above frame 105. It is understood that cross member 109 may be located beneath frame 105. This would elevate frame 105 further off the ground. This may be desirable as increased ground clearance acts to help prevent frame 105 from catching portions of rows of hay which can hinder the baler 97 from efficiently bailing the row.

A longitudinal rail 119 extends from support 117 and runs generally parallel with that of frame 105 for the purpose to help locate and support shaft 115. It may be coupled to cross member 109 in one or more locations, as shown, or it may only couple to frame 105 in instances wherein rail 119 and cross member 109 are below frame 105. Rail 119 is configured to support rake 103 and run generally parallel with frame 105. As seen in the figures, supports 117 extend between rail 119 and frame 105. The use of frame 105 with rail 119 increases the stability of caddy 101 in operation.

As seen in more clarity with FIG. 4 of the drawings, caddy 101 is configured to include various different wires and hoses to facilitate the functions of rake 103 and baler 97. Hydraulic hoses 121 and electrical wiring 123 are illustrated. Caddy 101 features 2 sets of hydraulic hoses 121 to enable seamless operation of baler 97. A diverter box 125 is configured to manage hydraulic flow to the hay rakes, baler pickup reel, and an extension wiring harness for baler operation and safety lighting. Box 125 may be coupled to cross member support 109 or any portion of frame 105, but may alternatively be coupled to any portion of caddy 101 that allows safe routing of wires and hoses. It is understood that extension wiring harnesses can be made for any brand or model of hay baler. This allows for an efficient operation of both the hay rakes and baler while ensuring compliance with road transport regulations.

It is understood that caddy 101 may further include wiring and hose retainers 127 which are configured to provide safe routing of the hoses and wiring along the length of frame 105. Retainers 127 can extend above or below rail 119. It is also understood that second end 113 may include a first hitch mount 129 to permit baler 97 the ability to releasably couple to frame 105. Likewise, first end 111 of frame 105 may include an alternate second hitch mount 131 to permit releasably coupling with tractor 97. Lastly, rotating shaft 115 may include a detachable locking mechanism 133 configured to engage with baler 97.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A hay rake caddy, comprising:
a frame having a first hitch mount at a first end and a second hitch mount at a second end;
a cross member coupled to the frame and configured to extend across the frame and elevate the frame above the ground;
a tire coupled to the cross member;
a rail running parallel with the frame, the rail including a rotating shaft extending from the first end to the second end; and
a hay rake coupled to the rail for gathering cut hay.

2. The caddy of claim 1, wherein the cross member extends over the frame.

3. The caddy of claim 1, wherein the cross member extends below the frame.

4. The caddy of claim 1, wherein the rail is coupled only to the frame.

5. The caddy of claim 1, further comprising:
hydraulic hoses extending between the first end and the second end, the hydraulic hoses coupled to the hay rake.

6. The caddy of claim 5, wherein the hay rake is configured to raise and lower with hydraulics.

7. The caddy of claim 1, further comprising:
electrical wiring to supply power.

8. The caddy of claim 1, wherein the frame includes a support to locate the rotating shaft.

9. The caddy of claim 1, wherein the rotating shaft includes a detachable locking mechanism configured to enable the rotating shaft to rotate.

10. The caddy of claim 1, wherein the cross member is located adjacent to the second end.

11. The caddy of claim 1, wherein the hay rake is configured to raise and lower with hydraulics.
